(19) United States
(12) Patent Application Publication
(10) Pub. No.: US 2025/0183306 A1
(43) Pub. Date: Jun. 5, 2025

(54) CATHODE SLURRY COMPOSITION FOR ALL-SOLID-STATE BATTERY AND A METHOD FOR PREPARING THE SAME

(71) Applicants: HYUNDAI MOTOR COMPANY, Seoul (KR); KIA CORPORATION, Seoul (KR)

(72) Inventors: So Ri Lee, Suwon-si (KR); Gyeong Jun Chung, Daejeon (KR); Seung Hwan Moon, Hwaseong-si (KR); Seul Gi Choi, Changwon-si (KR); Ju Yeon Lee, Busan (KR); Jong Jung Kim, Suwon-si (KR)

(73) Assignees: HYUNDAI MOTOR COMPANY, Seoul (KR); KIA CORPORATION, Seoul (KR)

(21) Appl. No.: 18/747,845

(22) Filed: Jun. 19, 2024

(30) Foreign Application Priority Data
Dec. 4, 2023 (KR) 10-2023-0173607

(51) Int. Cl. H01M 4/62; H01M 4/02; H01M 4/04

(52) U.S. Cl. CPC H01M 4/622; H01M 4/0416; H01M 2004/028

(57) ABSTRACT

A cathode slurry composition for an all-solid-state battery includes a rubber-based binder containing a polar functional group, a cathode active material, a solid electrolyte, and a complex solvent. The complex solvent contains a first solvent capable of dissolving the rubber-based binder and a second solvent capable of dispersing the cathode active material and the solid electrolyte. A Hansen parameter value δd of the first solvent is in a range from 19 to 25 MPa^{1/2}. A method for preparing the same is provided. A cathode for an all-solid-state battery manufactured from the cathode slurry composition and an all-solid-state battery includes the same.

### CROSS-REFERENCE TO RELATED APPLICATION

This application claims the benefit of priority to Korean Patent Application No. 10-2023-0173607, filed in the Korean Intellectual Property Office on Dec. 4, 2023, the entire contents of which are incorporated herein by reference.

### TECHNICAL FIELD

The present disclosure relates to a cathode slurry composition for an all-solid-state battery using a complex solvent, a method for preparing the same, a cathode for an all-solid-state battery manufactured from the cathode slurry composition, and an all-solid-state battery including the same.

### BACKGROUND

A secondary battery that may be charged and discharged is used as a large-capacity power storage battery used in an electric vehicle, a power storage system, and the like, or as a small, high-performance energy source for a portable electronic device such as a mobile phone, a camcorder, and a laptop. A lithium-ion battery, which is a representative secondary battery, has advantages of greater capacity for each unit area size, lower self-discharge rate, and no memory effect compared to a nickel-manganese battery or a nickel-cadmium battery, which are advantageous in terms of convenience of use.

However, because the lithium-ion battery uses a liquid electrolyte containing an organic solvent, it is difficult to provide stability of the battery because of leakage, shock, and the like caused by the use of the highly volatile organic solvent. Therefore, to provide safety of the lithium-ion battery, research on an all-solid-state battery using a solid electrolyte instead of the liquid electrolyte is actively underway.

Unlike the existing lithium-ion battery, the all-solid-state battery has advantages of not requiring a separator because the electrolyte is solid and having a low risk of explosion because heat is generated less. However, compared to the case of using the liquid electrolyte, chemical stability and price competitiveness of the solid electrolyte are poor and an energy density thereof is low, so that it is still difficult to commercialize the all-solid-state battery.

To solve such problems, thickening of a cathode is being attempted. To thicken the cathode in a mass wet process, a high-adhesion binder that may improve an adhesion of a mixture-substrate interface is required. However, the high-adhesion binder does not dissolve well in a solvent with a low polarity that is compatible with a sulfide-based solid electrolyte, which may make electrode production difficult.

Therefore, to increase the energy density of the all-solid-state battery, there is a need to develop a technology that may appropriately disperse a cathode active material and the solid electrolyte while utilizing a solvent that may dissolve the high-adhesion binder.

### SUMMARY

The present disclosure has been made to solve the above-mentioned problems occurring in the prior art while advantages achieved by the prior art are maintained.

An aspect of the present disclosure provides a cathode slurry composition for an all-solid-state battery using a first solvent that may dissolve a rubber-based binder containing a polar functional group and a second solvent that may disperse a cathode active material and a solid electrolyte, and a method for preparing the same.

Another aspect of the present disclosure provides a cathode for an all-solid-state battery manufactured from the cathode slurry composition for the all-solid-state battery, and an all-solid-state battery including the same.

The technical problems to be solved by the present disclosure are not limited to the aforementioned problems, and any other technical problems not mentioned herein are clearly understood from the following description by those having ordinary skill in the art to which the present disclosure pertains.

According to a first aspect of the present disclosure, a cathode slurry composition for an all-solid-state battery includes a rubber-based binder containing a polar functional group, a cathode active material, a solid electrolyte, and a complex solvent. The complex solvent contains a first solvent capable of dissolving the rubber-based binder and a second solvent capable of dispersing the cathode active material and the solid electrolyte. A Hansen parameter value δ_{d} of the first solvent is in a range from 19 to 25 MPa^{1/2}.

According to a second aspect of the present disclosure, a method for preparing a cathode slurry composition for an all-solid-state battery includes mixing a first solution, obtained by mixing a rubber-based binder containing a polar functional group and a first solvent with each other, with a second solution, obtained by mixing a cathode active material, a solid electrolyte, and a second solvent with each other.

According to a third aspect of the present disclosure, a cathode for an all-solid-state battery includes a current collector, and a cathode active material layer located on the current collector. The cathode active material layer contains a cathode active material, a solid electrolyte, and a rubber-based binder containing a polar functional group. A Hansen parameter value δ_{d} of the rubber-based binder containing the polar functional group is in a range from 19 to 25 MPa^{1/2}.

According to a fourth aspect of the present disclosure, an all-solid-state battery includes the cathode for the all-solid-state battery, an anode, and a solid electrolyte interposed between the cathode and the anode.

### DETAILED DESCRIPTION

Hereinafter, a lubricant composition and a method for preparing the same are described in detail such that those having ordinary skill in the art may easily practice the same.

A cathode slurry composition for an all-solid-state battery according to an embodiment of the present disclosure is a cathode slurry composition for an all-solid-state battery containing a rubber-based binder containing a polar functional group, a cathode active material, a solid electrolyte, and a complex solvent. The complex solvent may contain a first solvent that may dissolve the rubber-based binder and a second solvent that may disperse the cathode active material and the solid electrolyte. A Hansen parameter value δ_{d} of the first solvent may be in a range from 19 to 25 MPa^{1/2}.

A sulfide-based all-solid-state battery may utilize a solvent with a low polarity index to disperse the solid electrolyte. Therefore, because a binder with a low polarity is also utilized for the rubber-based binder contained in the slurry for the all-solid-state battery along with the solid electrolyte, an adhesion is low and thus detachment between a mixture and a substrate may occur.

Therefore, the present disclosure is to improve the adhesion between the mixture and the substrate by utilizing the rubber-based binder containing the polar functional group.

When using the rubber-based binder containing the polar functional group to improve the adhesion of the binder, it may be difficult to manufacture the all-solid-state battery because the rubber-based binder does not dissolve well in the solvent with the low polarity index.

Therefore, in the present disclosure, the complex solvent containing the first solvent that may dissolve the rubber-based binder containing the polar functional group and the second solvent that may disperse the cathode active material and the solid electrolyte is used to solve the solubility problem of the high-adhesion binder. In particular, the Hansen parameter value δ_{d} of the first solvent contained in the complex solvent is in the range from 19 to 25 MPa^{1/2}, enabling effective dissolving of the rubber-based binder with a high polarity index.

The first solvent may include a benzoate-based solvent, a carbonate-based solvent, a phthalate-based solvent, or a combination thereof.

The benzoate-based solvent contains benzoate as shown in Chemical Formula 1 below, the carbonate-based solvent contains a carbonate (ethylene carbonate) structure as shown in Chemical Formula 2 below, and the phthalate-based solvent contains a phthalate as shown in Chemical Formula 3 below.

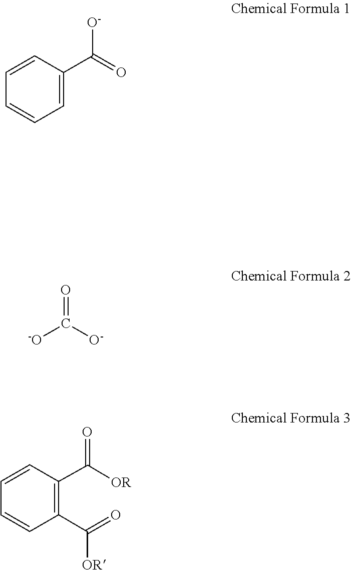

Because the benzoate-based solvent, the carbonate-based solvent, and the phthalate-based solvent may all contain —COO— (where C=carbon, O=oxygen) to easily dissolve a polar solute, the rubber-based binder containing the polar functional group may be effectively dissolved.

The benzoate-based solvent may include benzyl benzoate, n-propyl benzoate, isopropyl benzoate, butyl benzoate, isobutyl benzoate, sec-butyl benzoate, tert-butyl benzoate, isoamyl benzoate, or a combination thereof. In one example, the benzoate-based solvent may include ethyl benzoate, n-propyl benzoate, or a combination thereof.

The carbonate-based solvent may include ethylene carbonate, propylene carbonate, butylene carbonate, or a combination thereof. In one example, the carbonate-based solvent may include ethylene carbonate, propylene carbonate, or a combination thereof.

The phthalate-based solvent may include benzyl butyl phthalate, dimethyl phthalate, diisobutyl phthalate, dioctyl phthalate, diphenyl phthalate, bis-cumyl-phenyl isophthalate, dibutoxyethyl phthalate, butyl octyl phthalate, nonyl undecyl phthalate, di-iso octyl phthalate, dicapryl phthalate, or a combination thereof. In one example, the phthalate-based solvent may include benzyl butyl phthalate, diisobutyl phthalate, or a combination thereof.

Because the first solvent contains the polar functional group, the first solvent may exhibit a high polarity with a polarity index in a range from 3.0 to 5.0.

The polar functional group contained in the rubber-based binder may include a carboxyl group, a hydroxyl group, an ether group, a nitrile group, an ester group, an amine group, salts thereof, or a combination thereof. In one example, the polar functional group may include a carboxyl group, a hydroxyl group, an ether group, a nitrile group, or a combination thereof.

The rubber-based binder may achieve the high adhesion by containing the polar functional group, thereby improving an interfacial retention between a mixture structure within an electrode and a current collector and improving the adhesion between the mixture and the substrate.

A content of the polar functional group contained in the rubber-based binder may be 5 to 30% by weight.

By containing the polar functional group of the content within the above range, while the adhesion of the rubber-based binder may be effectively improved, appropriate dispersion in the slurry for the all-solid-state battery may be realized to prevent a resistance within the electrode from increasing. When the content of the polar functional group is too low, the adhesion of the rubber-based binder may decrease, and when the content of the polar functional group is too high, the resistance within the electrode may increase because the rubber-based binder does not sufficiently dissolve in the first solvent.

The rubber-based binder may include butadiene rubber (BR), styrene-butadiene rubber (SBR), styrene-butadiene-styrene (SBS), nitrile butadiene rubber (NBR), ethylene-propylene diene monomer (EPDM), styrene-butadiene-acrylontrile (SBN), styrene-isoprene-styrene (SIS), acrylic rubber (AR), or a combination thereof. In one example, the rubber-based binder may include butadiene rubber (BR), styrene-butadiene rubber (SBR), styrene-butadiene-styrene (SBS), nitrile-butadiene rubber (NBR), or a combination thereof.

A Hansen parameter value δ_{d} of the rubber-based binder containing the polar functional group is in a range from 19 to 25 MPa^{1/2}, so that the adhesion between the mixture and the substrate may be improved via the rubber-based binder containing the polar functional group.

The second solvent may include xylene, hexyl butyrate, hexane, heptane, cyclohexane, toluene, butyl butyrate, anisole, or a combination thereof. In one example, the second solvent may include xylene, hexyl butyrate, hexane, heptane, cyclohexane, or a combination thereof.

The second solvent may have a Hansen parameter value δ_{d} in a range from 15 to 18.5 MPa^{1/2} to effectively disperse the cathode active material and the solid electrolyte.

In addition, a polarity index of the second solvent may be in a range from 0 to 2.5 to be compatible with the cathode active material and the solid electrolyte.

Next, a method for preparing a cathode slurry composition for an all-solid-state battery according to another embodiment of the present disclosure is described in detail.

The method for preparing the cathode slurry composition for the all-solid-state battery according to one embodiment of the present disclosure may include mixing a first solution, obtained by mixing the rubber-based binder containing the polar functional group and the first solvent with each other, with a second solution, obtained by mixing the cathode active material, the solid electrolyte, and the second solvent with each other.

In the present disclosure, the complex solvent containing the first solvent that may dissolve the rubber-based binder and the second solvent that may disperse the cathode active material and the solid electrolyte is utilized, so that the first solution using the first solvent and the second solution using the second solvent may be separately prepared and mixed with each other.

In this regard, the second solution may be prepared by additionally mixing the second solvent with a dry mixture of the cathode active material and the solid electrolyte.

When the first solution obtained by mixing the rubber-based binder containing the polar functional group with the first solvent is first mixed with the dry mixture of the cathode active material and the solid electrolyte, not only the sulfide-based solid electrolyte and the first solvent may react to generate hydrogen sulfide, but also dispersibility between components in the electrode may decrease, which may increase the electrode resistance. Therefore, in the present disclosure, the second solution may be prepared by additionally mixing the second solvent with the dry mixture of the cathode active material and the solid electrolyte. Further, the second solution may be mixed with the first solution.

A content of the rubber-based binder in the first solution may be in a range from 5 to 10% by weight.

By containing the rubber-based binder of the content within the above range, while the adhesion between the mixture and the substrate may be improved without deteriorating a cell performance, maintenance, and connectivity between the components in the mixture may be improved.

The first solution may be prepared by stirring the rubber-based binder containing the polar functional group and the first solvent for 12 to 36 hours to sufficiently dissolve the rubber-based binder containing the polar functional group in the first solvent.

A content of the second solvent in the second solution may be in a range from 10 to 30% by weight.

By containing the second solvent of the content within the above range, dispersibility of the solid electrolyte may be improved to prepare the uniform cathode slurry for the all-solid-state battery.

A weight ratio of the first solvent and the second solvent may be in a range from 1:0.4 to 1:1.5.

Via the weight ratio of the first solvent and the second solvent within the above range, while the adhesion between the mixture and the substrate may be improved, agglomeration of the components within the electrode may be prevented to suppress the increase in the electrode resistance.

A cathode for the all-solid-state battery according to one embodiment of the present disclosure may include the current collector and a cathode active material layer located on the current collector. The cathode active material layer may contain the cathode active material, the solid electrolyte, and the rubber-based binder containing the polar functional group. The Hansen parameter value da of the rubber-based binder containing the polar functional group may be in the range from 19 to 25 MPa^{1/2}.

The current collector may include nickel, copper, zinc, aluminum, or any combination thereof.

The contents described above may be applied in the same way to the rubber-based binder containing the polar functional group.

In one example, the cathode active material layer may contain a residual solvent derived from the cathode slurry composition for the all-solid-state battery described above. More specifically, the residual solvent contains at least one of the first solvent having the Hansen parameter value δ_{d} in the range from 19 to 25 MPa^{1/2} and the second solvent having the Hansen parameter value δ_{d} in the range from 15 to 18.5 MPa^{1/2}. The contents described above may be applied in the same way to the first solvent and the second solvent.

The all-solid-state battery according to one embodiment of the present disclosure may include the cathode described above, an anode, and the solid electrolyte interposed between the cathode and the anode.

An anode and a solid electrolyte known in the art may be used.

Hereinafter, the present disclosure is described in more detail via Present Examples. However, such Present Examples are only intended to help understand the present disclosure, and the scope of the present disclosure is not limited to such Present Examples in any way.

### PRESENT EXAMPLES

### Present Example 1 Cathode Slurry Composition for all-Solid-State Battery Preparation 1

A butadiene rubber (BR) binder (δd: 19.9 MPa^{1/2}) containing 10% by weight of the carboxyl group (—COOH) (where C=carbon, O=oxygen, H=hydrogen) was mixed with propyl benzoate (δ_{d}: 19.5 MPa^{1/2} and polarity index: 4.0) utilized as a first solvent to form a mixture, and then, the mixture was stirred for 18 hours using a planetary disperser (P/D) mixer to prepare a first solution. In the first solution, a binder content was 6.5% by weight. In addition, a dry mixture obtained via dry mix of a cathode active material and a sulfide-based solid electrolyte using the planetary disperser (P/D) mixer was mixed with xylene (δ_{d}: 17.6 MPa^{1/2} and polarity index: 2.5) utilized as a second solvent to form a mixture, and then, the mixture was stirred for 18 hours using the planetary disperser (P/D) mixer to prepare a second solution. In the second solution, a content of xylene was 22.7% by weight.

The prepared first solution and the prepared second solution were stirred for 12 hours using the planetary disperser (P/D) mixer to prepare a cathode slurry composition for an all-solid-state battery. A weight ratio of the first solvent and the second solvent of the complex solvent contained in the cathode slurry composition for the all-solid-state battery was 1:0.76.

In this regard, the Hansen parameter value δ_{d} was calculated using a program called Hansen Solubility Parameters in Practice (HSPiP) developed by the Dr. C. Hansen group. Additionally, the polarity index refers to a Snyder polarity index.

### Present Example 2 Cathode Slurry Composition for all-Solid-State Battery Preparation 2

A cathode slurry composition for an all-solid-state battery was prepared in the same manner as Present Example 1 except that the first solution was mixed with the dry mixture obtained via the dry mix of the cathode active material and the sulfide-based solid electrolyte using the planetary disperser (P/D) mixer to form a mixture and then xylene used as the second solvent was mixed with the mixture.

### Present Example 3 Cathode Slurry Composition for all-Solid-State Battery Preparation 3

A cathode slurry composition for an all-solid-state battery was prepared in the same manner as Present Example 1 except that the dry mixture obtained via the dry mix of the cathode active material and the sulfide-based solid electrolyte using the planetary disperser (P/D) mixer, the first solution, and the second solvent were mixed with each other at the same time.

### Comparative Example 1 Cathode Slurry Composition for all-Solid-State Battery Preparation 4

A cathode slurry composition for an all-solid-state battery was prepared in the same manner as Present Example 1 except that the butadiene rubber (BR) binder that does not contain the polar functional group was utilized and xylene was utilized as the first solvent.

### Comparative Example 2 Cathode Slurry Composition for all-Solid-State Battery Preparation 5

A cathode slurry composition for an all-solid-state battery was prepared in the same manner as Present Example 1 except that xylene was utilized as the first solvent and propyl benzoate was utilized as the second solvent.

### Comparative Example 3 Cathode Slurry Composition for all-Solid-State Battery Preparation 6

A cathode slurry composition for an all-solid-state battery was prepared in the same manner as Present Example 1 except that a nitrile butadiene rubber (NBR) binder that does not contain the polar functional group was utilized, dibromomethane was utilized as the first solvent, and butyl butyrate was utilized as the second solvent.

### Experimental Example 1 Adhesion and Electrode Resistance Evaluation

First, the prepared Present Examples 1-3 and Comparative Examples 1-3 were coated on the current collector using a blade, and then vacuum dried (V/D) at 100° C. for 4 hours to prepare all-solid-state battery cathode specimens.

The adhesion was evaluated by measuring tensile strengths of the prepared all-solid-state battery cathode specimens at a speed of mm/min (millimeters per minute) with respect to a horizontal direction using a universal testing machine (UTM).

The electrode resistance was measured using an electrode resistance meter on the prepared all-solid-state battery cathode specimens (measurement conditions: current: 10 mA (milliampere) and voltage range: within 0.5 V (volt)).

The adhesion and resistance evaluation results are shown in Table 1 below.

TABLE 1

| | | Electrode |
|---|---|---|
| | Adhesion | resistance |
| Division | (gf/mm) | (Ω · cm²) |
| Present Example 1 | 1.95 | 2.25 * 10⁻² |
| Present Example 2 | 1.65 | 3.55 * 10⁻² |
| Present Example 3 | 1.60 | 3.03 * 10⁻² |
| Comparative | 0.28 | 2.20 * 10⁻² |
| Example 1 | | |
| Comparative | 0.85 | 3.23 * 10⁻² |
| Example 2 | | |
| Comparative | 0.70 | 2.75 * 10⁻² |
| Example 3 | | |

Referring to Table 1, Present Examples 1-3 all showed excellent adhesion at the mixture-substrate interface by utilizing the rubber-based binder containing the polar functional group.

In particular, Present Example 1 was prepared by first mixing the dry mixture obtained via the dry mix of the cathode active material and the sulfide-based solid electrolyte with xylene utilized as the second solvent to prepare the second solution, and then mixing the second solution with the first solution, so that the reaction between the sulfide-based solid electrolyte and the first solvent was suppressed and the dispersibility between the components in the electrode was increased, resulting in low electrode resistance.

However, Comparative Examples 1 and 3 showed poor adhesion at the mixture-substrate interface by utilizing the rubber-based binder without the polar functional group.

Although Comparative Example 2 utilizes the rubber-based binder containing the polar functional group, because Comparative Example 2 utilizes the first solvent that does not satisfy the Hansen parameter value δ_{d} in the range from 19 to 25 MPa^{1/2}, not only was low adhesion measured, but also the dispersibility between the components within the electrode was lowered, resulting in high electrode resistance.

According to one embodiment of the present disclosure, the interfacial retention between the mixture structure within the electrode and the current collector may be improved via the high-adhesion binder.

In addition, via the cathode slurry composition for the all-solid-state battery utilizing the first solvent that may dissolve the rubber-based binder containing the polar functional group and the second solvent that may disperse the cathode active material and the solid electrolyte, the solubility of the binder and the dispersibility of the slurry components may be increased to lower the resistance within the electrode.

Hereinabove, although the present disclosure has been described with reference to embodiments and the accompanying drawings, the present disclosure is not limited thereto, but may be variously modified and altered by those having ordinary skill in the art in the art to which the present disclosure pertains without departing from the spirit and scope of the present disclosure claimed in the following claims.

What is claimed is:

1. A cathode slurry composition for an all-solid-state battery, the cathode slurry composition comprising:
a rubber-based binder containing a polar functional group;
a cathode active material;
a solid electrolyte; and
a complex solvent,
wherein the complex solvent contains a first solvent capable of dissolving the rubber-based binder and a second solvent capable of dispersing the cathode active material and the solid electrolyte, and
wherein a Hansen parameter value δ_{d} of the first solvent is in a range from 19 to 25 MPa^{1/2}.

2. The cathode slurry composition of claim 1, wherein the first solvent comprises a benzoate-based solvent, a carbonate-based solvent, a phthalate-based solvent, or a combination thereof.

3. The cathode slurry composition of claim 2, wherein the benzoate-based solvent comprises benzyl benzoate, n-propyl benzoate, isopropyl benzoate, butyl benzoate, isobutyl benzoate, sec-butyl benzoate, tert-butyl benzoate, isoamyl benzoate, or a combination thereof.

4. The cathode slurry composition of claim 2, wherein the carbonate-based solvent comprises ethylene carbonate, propylene carbonate, butylene carbonate, or a combination thereof.

5. The cathode slurry composition of claim 2, wherein the phthalate-based solvent comprises benzyl butyl phthalate, dimethyl phthalate, diisobutyl phthalate, dioctyl phthalate, diphenyl phthalate, bis-cumyl-phenyl isophthalate, dibutoxyethyl phthalate, butyl octyl phthalate, nonyl undecyl phthalate, di-iso octyl phthalate, dicapryl phthalate, or a combination thereof.

6. The cathode slurry composition of claim 1, wherein a polarity index of the first solvent is in a range from 3.0 to 5.0.

7. The cathode slurry composition of claim 1, wherein the polar functional group contained in the rubber-based binder comprises a carboxyl group, a hydroxyl group, an ether group, a nitrile group, an ester group, an amine group, a salt thereof, or a combination thereof.

8. The cathode slurry composition of claim 1, wherein a content of the polar functional group contained in the rubber-based binder is in a range from 5 to 30% by weight.

9. The cathode slurry composition of claim 1, wherein the rubber-based binder comprises butadiene rubber (BR), styrene-butadiene rubber (SBR), styrene-butadiene-styrene (SBS), nitrile butadiene rubber (NBR), ethylene-propylene diene monomer (EPDM), styrene-butadiene-acrylontrile (SBN), styrene-isoprene-styrene (SIS), acrylic rubber (AR), or a combination thereof.

10. The cathode slurry composition of claim 1, wherein a Hansen parameter value δ_{d} of the rubber-based binder containing the polar functional group is in a range from 19 to 25 MPa^{1/2}.

11. The cathode slurry composition of claim 1, wherein the second solvent comprises xylene, hexyl butyrate, hexane, heptane, cyclohexane, toluene, butyl butyrate, anisole, or a combination thereof.

12. The cathode slurry composition of claim 1, wherein a Hansen parameter value δ_{d} of the second solvent is in a range from to 18.5 MPa^{1/2}.

13. The cathode slurry composition of claim 1, wherein a polarity index of the second solvent is in a range from 0 to 2.5.

14. A method for preparing a cathode slurry composition for an all-solid-state battery, the method comprising:
mixing a rubber-based binder containing a polar functional group and a first solvent to form a first solution;
mixing a cathode active material, a solid electrolyte, and a second solvent to form a second solution; and
mixing the first solution with the second solution to form the cathode slurry composition.

15. The method of claim 14, wherein the second solution is prepared by additionally mixing the second solvent with a dry mixture of the cathode active material and the solid electrolyte.

16. The method of claim 14, wherein a content of the rubber-based binder in the first solution is in a range from 5 to 10% by weight.

17. The method of claim 14, wherein a content of the second solvent in the second solution is in a range from 10 to 30% by weight.

18. The method of claim 14, wherein a weight ratio of the first solvent and the second solvent is in a range from 1:0.4 to 1:1.5.

19. A cathode for an all-solid-state battery, the cathode comprising:
a current collector; and
a cathode active material layer located on the current collector,
wherein the cathode active material layer contains a cathode active material, a solid electrolyte, and a rubber-based binder containing a polar functional group, and
wherein a Hansen parameter value δ_{d} of the rubber-based binder containing the polar functional group is in a range from 19 to 25 MPa^{1/2}.

20. An all-solid-state battery comprising:
a cathode;
an anode; and
a solid electrolyte interposed between the cathode and the anode,
wherein the cathode comprises:
a current collector; and
a cathode active material layer located on the current collector,
wherein the cathode active material layer contains a cathode active material, a solid electrolyte, and a rubber-based binder containing a polar functional group, and
wherein a Hansen parameter value δ_{d} of the rubber-based binder containing the polar functional group is in a range from 19 to 25 MPa^{1/2}.
